(19) United States
(12) Patent Application Publication
(10) Pub. No.: US 2003/0010321 A1
(43) Pub. Date: Jan. 16, 2003

(54) Air intake device for an internal combustion engine with crankcase ventilation

(75) Inventors: Klaus Rentschler, Gaeufelden (DE); Werner Wagner, Ludwigsburg (DE)

Correspondence Address: CROWELL & MORING LLP, INTELLECTUAL PROPERTY GROUP, P.O. BOX 14300, WASHINGTON, DC, 20044-4300, US

(73) Assignee: Filterwerk Mann & Hummel GmbH, Ludwigsburg (DE)

(21) Appl. No.: 10/179,015

(22) Filed: Jun. 26, 2002

(30) Foreign Application Priority Data
Jun. 27, 2001 (DE) 101 31 004.8

(51) Int. Cl. F02M 25/06

(52) U.S. Cl. 123/472; 123/184.42

(57) ABSTRACT

An air intake device for an internal combustion engine with crankcase ventilation in which crankcase gases are conducted via a duct structure (25) into the interior (18) of the air intake device (10). The duct structure ensures a quasi cylinder-selective feed through a plurality of feed inlets (27) into individual intake channels (20a). The duct structure is formed by the wall of the intake manifold and is sealed by a cover, so that the intake manifold can be produced cost-effectively. This construction has the advantage of ensuring uniform distribution of the crankcase gases among the cylinders while simultaneously enabling economically efficient manufacture.

### BACKGROUND OF THE INVENTION

The invention relates to an air intake device for an internal combustion engine with crankcase ventilation, comprising a duct structure for introducing the crankcase gases into the interior of the intake device.

Air intake devices of the above-described type are known, for example, from German Patent Specification DE 42 29 408 C1. According to the single figure of this document, an intermediate plate 17, which is placed in a flanged joint of the intake device, is provided for guiding the crankcase gases into the interior of the intake manifold. One of the flanges has a duct structure A, B, which together with the intermediate plate forms the duct structures for introducing the crankcase gases. For this purpose, the intermediate plate is provided with corresponding bores 15 or other passages 16.

The crankcase gas can be introduced through these bores and passages into the intake stream just behind the throttle valve in such a way that it mixes with the intake air. However, the result achieved is not completely homogenous, so that the crankcase gases cannot be supplied to the individual cylinders in absolutely equal parts. On the other hand, it is possible—with the aid of the intermediate plate—to form the duct structure for introducing the crankcase gases in a cost-effective manner, so that this proposed solution achieves a high degree of cost effectiveness.

### SUMMARY OF THE INVENTION

It is an object of the invention to provide an improved air intake device for an internal combustion engine with crankcase gas ventilation.

It is also an object of the invention to provide an air intake device which produces a homogenous distribution of recirculated crankcase gases among the individual cylinders of the internal combustion engine.

A further object of the invention is to provide an air intake device for an internal combustion engine with crankcase ventilation which can be economically manufactured.

Another object of the invention is to provide an air intake device for an internal combustion engine with crankcase ventilation, comprising an economically producible duct structure for introducing recirculated crankcase gases into the interior of the air intake device.

These and other objects are achieved in accordance with the present invention by providing an air intake device for an internal combustion engine with crankcase gas ventilation, comprising a housing having an air inlet connected through a plenum chamber and a plurality of intake channels to a plurality of air outlets, and a duct structure leading from a gas connection for connection with the crankcase to a plurality of feed inlets that open into the interior of the air intake device in order to introduce recirculated crankcase gases; in which at least a portion of the duct structure is formed by a separately produced partition together with the wall parts of the housing, and the plurality of feed inlets are formed in the partition, and a respective one of the feed inlets is provided for each intake channel of the air intake device.

The air intake device according to the invention comprises a plenum from which the intake channels branch off in known manner. The intake channels end in outlets, which can be connected with the combustion chambers of the engine cylinders and which for this purpose are generally provided with a cylinder head flange or with elastic coupling elements. The air intake device further comprises an inlet for the intake air, which normally opens out into the plenum. The air intake device can further have a throttle valve in front of the inlet. This throttle valve may be, for instance, flanged to the inlet.

Furthermore, a duct structure suitable for introducing the recirculated crankcase gases into the intake air is integrated in the intake device. For this purpose, feed inlets are provided, which connect the duct structure with the interior space of the air intake device. In addition, a gas connection is provided, which can be connected with the crankcase. The connection does not have to be a direct connection but can also be achieved via a hose or duct.

The air intake device can have more than one intake channel per cylinder, in which case one of the channels is longer and the other one shorter. A shut-off member is arranged in the short intake channel, such that the short channel is opened only at increased speeds of the internal combustion engine. At low engine speeds, the intake air is aspirated in through the longer path of the other intake channel.

The invention is characterized in that the partition, which forms the duct structure for feeding the crankcase gas, forms a separate feed inlet for each intake channel. This achieves a cylinder-selective or quasi cylinder-selective feeding of the crankcase gases. This means that the same amount of crankcase gas is fed into each intake port, so that uniform combustion in the internal combustion engine is facilitated. This has a positive influence on the characteristics of the engine exhaust gas, so as to minimize environmental pollution by the internal combustion engine.

The cylinder-selective feed inlets can also be arranged in such a way that they can serve both the aforementioned long and the short intake channels of the respective cylinders. In both switching states, the intake air stream entrains the introduced crankcase gas. It is only important that each feed inlet essentially supplies one of the cylinders with crankcase gases, such that the quasi-selective feed continues to be ensured.

In accordance with one specific embodiment of the invention, the partition is welded into the volume formed by the air intake device. This means that welding is effected on the inside of the housing of the air intake device. Thus the partition and the wall of the housing together form the duct structures for the crankcase gases. Since the duct structures thus extend along the interior, the feed inlets can be readily installed. This welding-in process is particularly suitable for plastic pipes.

Disposing the partition in the interior of the intake manifold makes it possible using only a simple component to create complex duct structures with feed inlets for each individual intake channel. This provides an economically efficient solution while simultaneously facilitating optimization of the distribution of the crankcase gases among the individual cylinders.

A further embodiment of the invention provides that the air intake device be made of individual shells which are welded together. Vibration welding, for example, is suitable for this purpose. In this case, the partition is configured as one of these shells and at a suitable point in the production process can be welded together with the manifold shell, with which it communicates to form the duct structures.

A significant advantage of introducing the partition into an air intake device comprised of a plurality of shells is accessibility. The partition can be disposed in the interior space of the intake manifold before the manifold is closed up by welding the intake manifold shells together. In principle, however, the welding-in is also possible in a prefabricated air intake device, if such a prefabricated assembly is installed in the plenum, e.g., via the inlet. In this case, however, a different joining method is suggested, e.g., a clip-in method.

It should be noted in this regard that it is not necessary to completely seal the duct structures relative to the interior space of the intake device. If there are leaks, the crankcase gas is nevertheless fed into the interior space of the intake device since the latter is completely arranged in the interior. This results in another significant advantage compared to the prior art embodiment which utilizes a partition constructed as an intermediate flange.

Another embodiment of the invention provides that the partition be produced as an integral part of an assembly of air intakes. The air intakes form the openings between the plenum and the intake passages. This is to say that the openings are frequently take the form of a bell-shaped expansion to improve the intake behavior of the air intake device. Because of the need to avoid undercuts in forming the parts of the device, these additional components must in any case be installed separately in the air intake device. Integrating the partition into such a component thus reduces additional production complexity, which helps to assure that the air intake device can be manufactured economically.

Integral production of the partition and the assembly of intakes thus means that this part is a single component prior to assembly with the air intake device. It can be produced, for instance, by originally forming the partition and intake assembly as a single part, i.e., by injection molding in the case of a plastic component. After installation of the partition and intake assembly into the air intake device, e.g., by welding, the partition and intake assembly can also form a single component with the rest of the air intake device. It can also be made in several parts, however, if a detachable connection such as the aforementioned clip connection is preferred.

One advantageous embodiment of the invention provides that the duct structure be formed in such a way that the paths traveled between the gas connection and the individual feed inlets are all substantially identical in length. This makes it possible to further equalize the distribution of the crankcase gases among the individual feed inlets, which enhances a cylinder-selective feed into the intake manifold. A symmetrical arrangement of the individual ducts in the duct structure is especially advantageous. A symmetrical course additionally makes it possible to achieve similar, e.g., mirrored courses of the crankcase gas stream. This additional homogenizing effect results in a uniform feed of the crankcase gases through the individual feed inlets.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments shown in the accompanying drawings, in which:

FIG. 1 is a section through the inventive intake manifold in the plane of the intake ports; and

FIG. 2 is a section along line A-A according to FIG. 1.

### DETAILED DESCRIPTION OF PREFERRED EMBODIMENTS

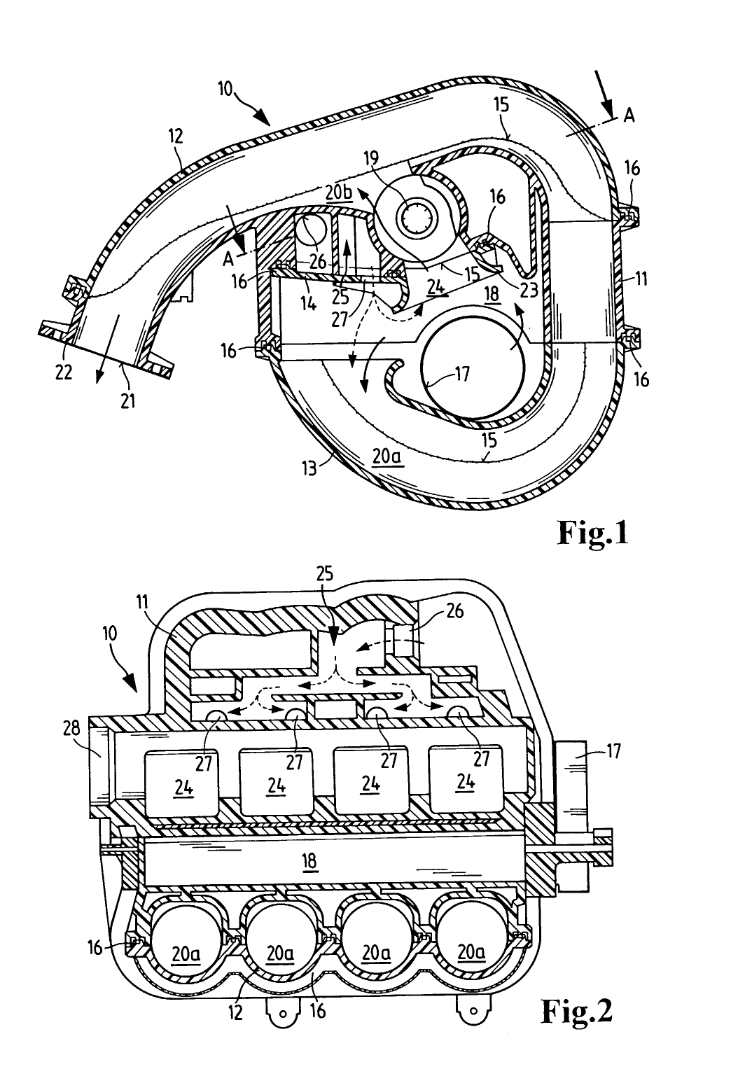

FIG. 1 shows an air intake device, which comprises a housing 10 produced by a multi-shell process. The housing has a basic body 11, an upper shell 12, a lower shell 13 and a partition 14. The shells are vibration welded together in a sequence that is suitable with respect to accessibility. For this purpose, welding edges 16 are provided along joints 15 between the shells.

The function of the air intake device is best explained by the path of the intake air through the interior space of the device. The path of the intake air is indicated by solid arrows. The air flows through an inlet 17 into a plenum 18 from where it is guided as a function of the position of a drum controller 19 (shown in its open position in FIG. 1) either into an intake channel 20a or primarily into an intake channel 20b. Through the intake channels 20a, 20b, the intake air passes to a respective outlet 21, which in the intake manifold shown in FIG. 1 forms a cylinder head flange 22 for mounting to the cylinder head of an internal combustion engine (not shown).

One of the shells is formed as a partition 14. Integrated in partition 14 are a plurality of bell-shaped intakes 23, which form the openings 24 between the plenum 18 and the short intake channels 20b. Furthermore, partition 14 serves as a cover for a duct structure 25, which is formed by wall parts of the basic body 11. This duct structure functions to introduce crankcase gases from the crankcase (not shown) of the internal combustion engine into the plenum 18 of the air intake device 10.

The duct structure has a gas connection 26, which can be connected with the crankcase. The opposite end of the duct structure is provided with several feed inlets 27, only one of which is visible in FIG. 1. Through these feed inlets, the recirculated crankcase gas, represented by a broken line arrow, is guided quasi cylinder-selectively either into the long intake channels 20a or into the short intake channels 20b. The cylinder selectivity is not absolute since the introduced crankcase gas is conducted through the common plenum. However, based on the given flow conditions, a direct assignment or association of the respective feed inlets 27 to the corresponding intake ports 20a, 20b is possible.

The course of the duct structure 25 is better seen in FIG. 2. The tree-like structure, with gas connection 26 as the trunk and with the individual branches leading to separate feed inlets 27 at their ends, is clearly evident. The broken line arrows indicate how the stream of crankcase gas branches out symmetrically, so that a very uniform flow through the feed inlets 27 is achieved. The plenum 18 is arranged below the feed inlets.

Also visible is an opening 28, which serves to receive the drum controller 19, shown only in FIG. 1. After installation of the drum controller, the opening is sealed with a cover (not shown). The other components have already been described above with reference to FIG. 1 and carry corresponding reference numerals.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations falling within the scope of the appended claims and equivalents thereof.

What is claimed is:

1. An air intake device for an internal combustion engine with crankcase gas ventilation, comprising:
a housing having an air inlet connected through a plenum chamber and a plurality of intake channels to a plurality of air outlets; and
a duct structure leading from a gas connection leading for connection with the crankcase to a plurality of feed inlets that open into the interior of the air intake device for introducing recirculated crankcase gases;
wherein at least a portion of said duct structure is formed by a separately produced partition together with the wall parts of said housing, and
wherein said plurality of feed inlets are formed in said partition, and a respective one of said feed inlets is provided for each intake channel of the air intake device.

2. An air intake device according to claim 1, wherein said partition is welded inside the interior of the air intake device.

3. An air intake device according to claim 2, wherein the air intake device comprises individual shells that are welded together, and said partition is embodied as one of said shells.

4. An air intake device according to claim 1, wherein said partition is integrally produced together with an assembly of intakes, and said intakes form openings between the plenum and the intake channels.

5. An air intake device according to claim 4, wherein a relatively long intake channel and a comparatively shorter sealable intake channel are provided for each cylinder of the engine, and said intakes produced integrally with the partition are arranged so that each said intake opens into a respective one of said shorter intake channels.

6. An air intake device according to claim 1, wherein said duct structure defines a plurality of paths of substantially equal length traversed by recirculated exhaust gas between the gas connection and each of the feed inlets, respectively.

7. An air intake device according to claim 6, wherein said duct structure divides into individual branches which are substantially symmetrical.
